(19) United States
(12) Patent Application Publication
(10) Pub. No.: US 2015/0249710 A1
(43) Pub. Date: Sep. 3, 2015

(54) SYSTEMS AND METHODS FOR EVENT DIGITAL MEDIA FILE MANAGEMENT

(71) Applicant: Snapathon, LLC, Phoenix, AZ (US)

(72) Inventors: Hafthor Stefansson, Phoenix, AZ (US); Brett Tyler McKinney, San Tan Valley, AZ (US); Gaurav Parekh, Scottsdale, AZ (US); William Rossiter, Redwood City, CA (US)

(73) Assignee: Snapathon, LLC, Phoenix, AZ (US)

(21) Appl. No.: 14/635,686

(22) Filed: Mar. 2, 2015

Related U.S. Application Data
(60) Provisional application No. 61/946,442, filed on Feb. 28, 2014.

(51) Int. Cl. H04L 29/08; G06F 21/62

(52) U.S. Cl. CPC H04L 67/1097; G06F 21/6209

(57) ABSTRACT

Systems and methods are disclosed herein for crowd-sourced digital media file management. During public events, such as a marathon, many photographs and videos may be taken of the event and the participants in the event. A photographer may upload reduced quality digital media file previews taken of the event by the photographer, and the photographer may upload the associated high quality digital media files to a cloud storage system. The photographer and consumers viewing digital media file previews may tag the digital media file previews with metadata about the digital media file previews, such as the identities of individuals in the digital media file previews. A consumer may search for images containing specific metadata, and may purchase a high quality digital media file associated with the preview file.

### CROSS-REFERENCE TO RELATED APPLICATIONS

This application is a nonprovisional of, and claims priority to, and the benefit of U.S. Application No. 61/946,442, entitled “SYSTEMS AND METHODS FOR EVENT DIGITAL MEDIA FILE MANAGEMENT,” filed on Feb. 28, 2014, which is hereby incorporated by reference in its entirety.

### FIELD

The present disclosure generally relates to digital media distribution, and more particularly to systems and methods for distributing digital media of an event.

### BACKGROUND

Many events, such as races, involve event participants with identifying information displayed, such as on a bib. There may be many digital media files, such as photographs and videos of the event, taken of the event participants during the event. However, it may be difficult for a photographer to coordinate with the event participants in order for the individuals to obtain their desired files. Furthermore, for a system to manage many digital media files, the system may require access to large amounts of bandwidth and storage, which may be costly to obtain and maintain.

### SUMMARY

Systems, methods, and computer-readable media for event digital media management are disclosed. A method may include receiving, by a computer-based system for digital media distribution, a digital media file preview from a mobile device. The system may apply a watermark to the digital media file preview. The system may sign the digital media file preview using a first key. The system may transmit the digital media file preview to a cloud storage system, wherein the cloud storage system accepts the digital media file preview signed by the system, and wherein the cloud storage system stores the digital media file preview. The system may receive a request from the mobile device to upload an original media file associated with the digital media file preview to the cloud storage system. The system may sign the request to upload the original media file using a second key. The system may transmit the request to the mobile device, wherein the mobile device transmits the request and the original media file to the cloud storage system. The system may receive a purchase request from a consumer for the original media file. The system may sign the purchase request with a third key. The system may transmit the purchase request to the cloud-storage system.

### BRIEF DESCRIPTION OF THE DRAWINGS

A more complete understanding may be derived by referring to the detailed description and claims when considered in connection with the Figures, wherein like reference numbers refer to similar elements throughout the Figures, and:

FIG. 1 illustrates a schematic diagram of a system for event digital media distribution according to various embodiments of the disclosure; and

FIG. 2 illustrates a process for event digital media distribution according to various embodiments.

### DETAILED DESCRIPTION

The detailed description of exemplary embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Systems, methods and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

Systems and methods are disclosed herein for crowd-sourced digital media or other digital media management. During public events, such as a marathon, many photographs and videos may be taken of the event and the participants in the event. A photographer may upload reduced quality digital media file previews taken of the event by the photographer to a media distribution system, and the photographer may upload the associated high quality original digital media to a cloud storage system. The photographer and consumers viewing file previews may tag the previews with metadata, such as the identities of individuals in the previews. A consumer may search previews for specific metadata associated with the previews, and may purchase a high quality digital media file or versions of the original file associated with the preview in certain embodiments.

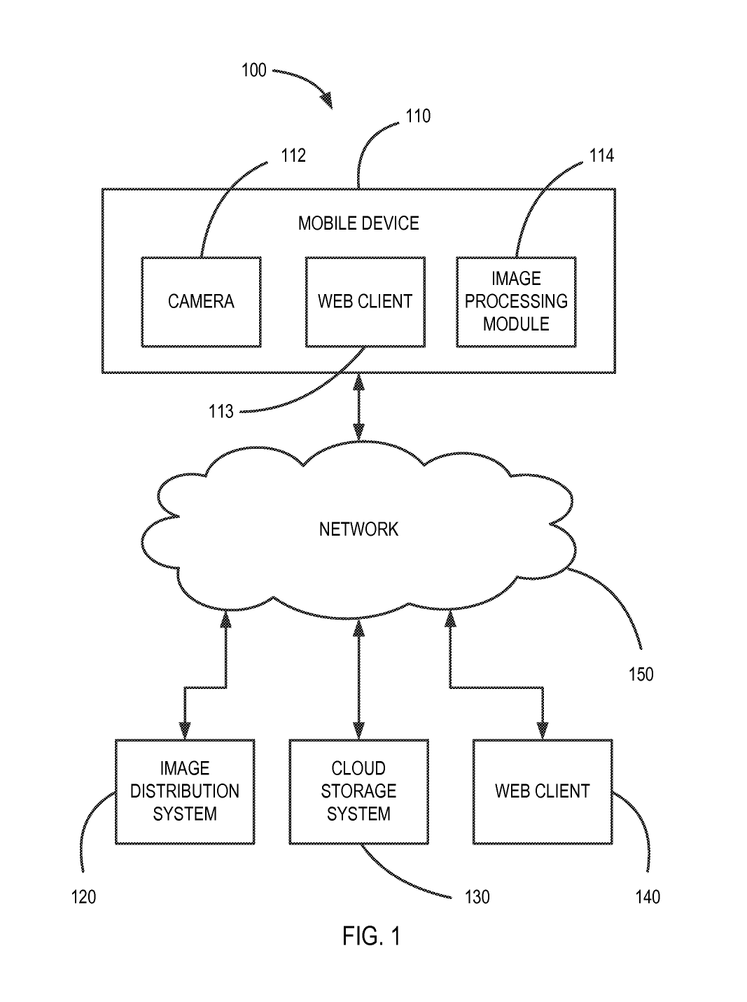

Referring to FIG. 1, a system 100 for managing digital media files is illustrated according to various embodiments. System 100 may comprise mobile device 110, media file distribution system 120, cloud storage system 130, and web client 140. Mobile device 110 may comprise any device capable of capturing or recording media files. Mobile device 110 may be primarily described herein with reference to a mobile phone comprising a camera. However, mobile device 110 may comprise any other recording device such as a digital camera, video camera, audio recorder, etc. Mobile device 110 may comprise a camera 112, a web client 113 and a media file processing module 114.

Media file processing module 114 may comprise any combination of hardware and/or software. In various embodiments, media file processing module 114 may comprise a micro-application that may be downloaded onto mobile device 110. Media file processing module 114 may be configured to generate digital media file previews of digital media captured by camera 112. Media file processing module 114 may be further configured to wirelessly communicate with various servers over a network.

Media file distribution system 120 may comprise any combination of hardware and or software. In various embodiments, media file distribution system 120 may comprise a remote server and one or more databases. Media file distribution system 120 may operate a web client 140 such as a webpage that may be accessible to users over the Internet. Media file distribution system 120 may be configured to store digital media file previews and associate metadata with the original digital media and associated file previews. Media file distribution system 120 may comprise keys that may sign requests from system 100 to allow users of system 100 to upload high-quality digital media files to cloud storage system 130. Media file distribution system 120 may comprise keys that may sign requests from system 100, web client 140 or web client 113 to allow users of system 100 to download or receive transmissions containing high-quality digital media files or unique data to access high-quality media files from cloud storage system 130.

Cloud storage system 130 may comprise a shared pool of configurable computing resources (e.g., networks, servers, storage, applications, and services) that can be rapidly provisioned and released with minimal management effort or service provider interaction. Cloud storage system 130 may include location-independent computing, whereby shared servers provide resources, software, and data to computers and other devices on demand. In various embodiments, cloud storage system 130 may comprise an online file storage web service, such as AMAZON® S3. Cloud storage system 130 may comprise keys shared with media file distribution system 120 that may accept requests from system 100 to store and grant access to media files.

Web client 140 or web client 113 may include any device (e.g., personal computer) that communicates via any network, for example such as those discussed herein. Web client 113 or web client 140 may comprise browser applications comprising Internet browsing software installed within a computing unit or a system to conduct online transactions and/or communications. These computing units or systems may take the form of a computer or set of computers, although other types of computing units or systems may be used, including smartphones, laptops, notebooks, tablets, hand held computers, personal digital assistants, set-top boxes, workstations, computer-servers, main frame computers, mini-computers, PC servers, pervasive computers, network sets of computers, personal computers, such as iPads, iMacs, and MacBooks, kiosks, terminals, point of sale (POS) devices and/or terminals, televisions, or any other device capable of receiving data over a network. A web client 113 or a web client 140 may run Microsoft Internet Explorer, Mozilla Firefox, Google Chrome, Apple Safari, or any other of the myriad software packages available for browsing the internet.

The various system components may communicate via network 150. Network 150 may include any cloud, cloud computing system or electronic communications system or method that incorporates hardware and/or software components. Communication among the various system components may be accomplished through any suitable communication channels, such as a telephone network, an extranet, an intranet, Internet, point of interaction device (point of sale device, personal digital assistant (e.g., iPhone®, Palm Pilot®, Blackberry®, cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality.

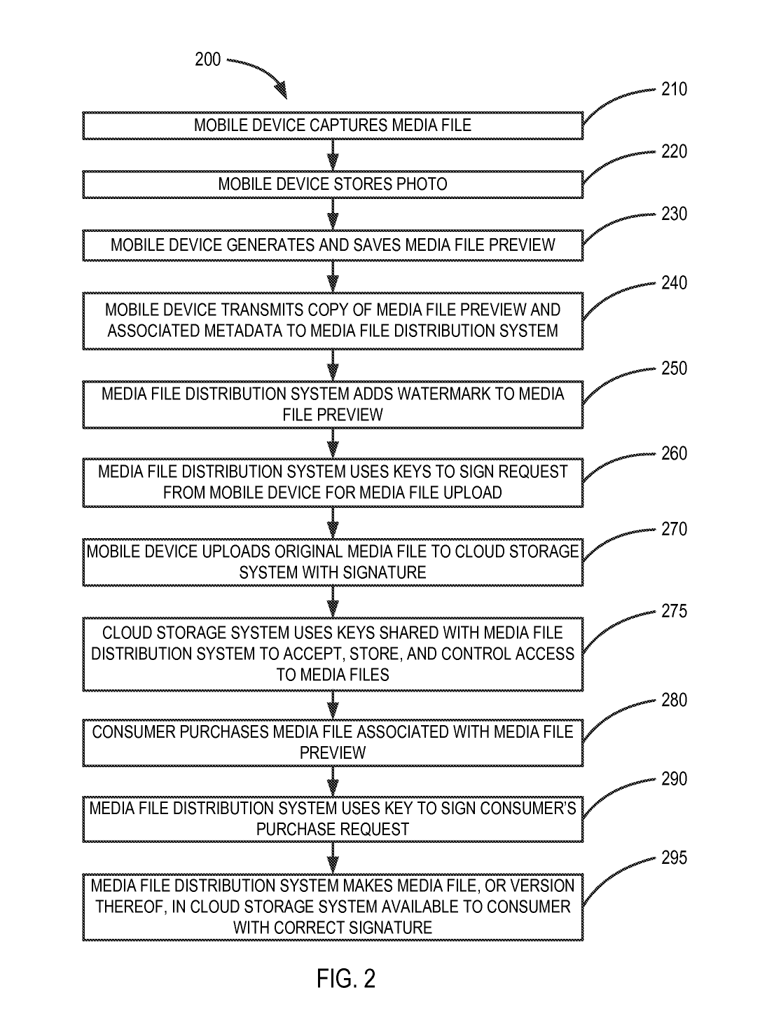

Referring to FIG. 2, a process for coordinating digital media distribution is illustrated according to various embodiments. A mobile device 110 may take a digital media file (step 210). As used herein, a digital media file may refer to any media captured by mobile device 110. For example, a digital media file may comprise a photograph, a video recording with or without audio, an audio recording, or any other media recorded by mobile device 110. In various embodiments, the mobile device 110 may use geographic location technology, date and/or time to identify the race at which the photographer is capturing digital media files. However, in various embodiments, the photographer may select a race from a list of races. In various embodiments, the media may be captured beyond the race duration and location, such as during race check-in, post-race awards ceremonies, during race preparation or travel to or from the race. In various embodiments, the mobile device 110 may be operated by a human photographer. However, in various embodiments, the mobile device 110 may be automated such that human intervention is not required to capture the digital media file. In various embodiments, the digital media file may be of a participant in a race. However, in various embodiments the digital media file may be of any person or object.

The mobile device 110 may store the digital media file on the mobile device (step 220).

The digital media file may be stored in digital format on a physical memory of the mobile device 110. The mobile device 110 may store metadata associated with the digital media file. Metadata may refer to data that describes the digital media file or any properties of the digital media file. In various embodiments, metadata may comprise the time the digital media file was taken, a geographic location of the digital media file, an event associated with the digital media file, and/or identifying information of the photographer or mobile device used to take the digital media file. The mobile device 110 may identify a geographic location, such as a latitude and longitude of the mobile device 110. The mobile device 110 may store the latitude and longitude as metadata associated with the digital media file.

The mobile device 110 may generate a digital media file preview of the digital media file or other digital media (step 230). The digital media file preview may be a smaller file size than the digital media file. In various embodiments, the mobile device 110 may compress the digital media file in order to generate a digital media file preview that is of lower resolution and/or quality than the digital media file. In various embodiments, the digital media file preview may be a cropped portion of the digital media file. In embodiments where the mobile device 110 captures a video, the digital media file preview may comprise a still image from the video, a GIF, a watermarked version of the video or a short segment of the video.

The mobile device 110 may save a copy of the original digital media file. In various embodiments, the mobile device 110 may save a copy of the preview associated with the original digital media file. In various embodiments, the original digital media file or associated preview saved on mobile device 110 may be transmitted to consumers to encourage consumers to view digital media created by users of mobile device 110. Additionally, in various embodiments photographers may download the digital media items that they created.

The mobile device 110 may upload the digital media file preview and the associated metadata to a media file distribution system 120 (step 240). In various embodiments, the mobile device 110 may automatically upload the digital media file preview to the media file distribution system 120 in response to the creation of the digital media file by mobile device 110. However, in various embodiments, a user may manually select preview files to be uploaded to the media file distribution system 120. In various embodiments, a digital media file preview may be uploaded in response to the photographer associating metadata with the preview. In various embodiments, the metadata may be an event participant number, an indication that the digital media file preview is associated with a high quality digital media file, or any other metadata. The media file distribution system 120 may store the metadata associated with the digital media file preview on a database. The media file distribution system 120 may add a watermark to the digital media file preview (step 250). The watermark may indicate that the digital media file is only a preview and may discourage consumers from capturing the digital media file preview as opposed to purchasing the full quality digital media file or variation thereof. The media file distribution system 120 may upload the watermarked digital media file preview to a remote storage system, such as cloud storage system 130. However, in various embodiments, the mobile device 110 may add a watermark to the digital media file preview, and the mobile device 110 may upload the preview with the watermark directly to cloud storage system 130. The cloud storage system 130 may store the digital media file preview in a public storage, such that users may view the digital media file preview without purchasing the full quality digital media file.

The media file distribution system 120 may include keys that sign requests from mobile device 110 to allow the mobile device 110 to upload an original digital media file to the cloud storage system 130 (step 260). The signature may be unique to the digital media file that the mobile device 110 sends to the cloud storage system 130. In various embodiments, the media file distribution system 120 may include keys that add signatures to preview files either stored in media file distribution system 120, stored in mobile device 110 or transmitted to cloud storage system 130 for storage.

The mobile device 110 may upload the original media file to cloud storage system 130 120 (step 270). In various embodiments, the mobile device 110 may automatically upload the original media file to cloud storage system 130 in response to the creation of the digital media file by mobile device 110. However, in various embodiments, a user may manually select original digital media files or their associated previews in order to upload original files to cloud storage system 130. Thus, users may avoid uploading digital media items with which they are not satisfied, which reduces both the data transmissions to network 150, and the accompanying battery power required for the data transmissions by mobile device 110. The cloud storage system 130 may store the original media file in a private storage, such that users are not permitted to view the original media file without a request signed by the media file distribution system 120.

In various embodiments, the mobile device 110 may upload digital media files individually. However, in various embodiments, the mobile device 110 may upload batches of digital media files. A batch of digital media files may be signed with a single key. A batch may be created in a variety of methods. For example, a user may select multiple digital media files and create a batch, the mobile device 110 may automatically create a batch based on a number of digital media files captured by the mobile device 110, or the mobile device 110 may automatically create a batch based on a set time period or event, such as one batch per minute or event.

In various embodiments, users may choose within media file processing module 114 the type of connection to network 150 they require for mobile device 110 in order to upload original media files to cloud storage system 130. Thus, users may delay uploading original media files to cloud storage system 130 until they are using a connection with greater bandwidth, a connection for which data transmission costs less, or a connection that requires less mobile device 110 battery consumption. However, in various embodiments the digital media preview media item may be uploaded to system 100 even if the original file is uploaded at a later time. In various embodiments, an original media file may be uploaded in response to the photographer associating metadata with the original digital media file or associated preview. In various embodiments, the metadata may be an event participant number, an indication that a preview is associated with a high quality digital media file, or any other metadata. The media file distribution system 120 or cloud storage system 130 may capture and store the metadata associated with the original media file on a database. The mobile device 110 may add a watermark to the original media file. The watermark may discourage consumers from capturing the full quality digital media file through various means as opposed to purchasing the full quality digital media file without watermark.

The cloud storage system 130 may include shared keys with mobile device 110 or media file distribution system 120 in order to validate requests to access or store files in cloud storage system 130 (step 275). Without the signature originating from media file distribution system 120, the mobile device 110 or media file distribution system 120 may be prevented from uploading either original digital media files, associated preview files, or variations thereof to the cloud storage system 130. Without the signature originating from media file distribution system 120, system 100 may be prevented from accessing or downloading original digital media files, associated preview files or variations thereof in cloud storage system 130.

A consumer may wish to view and/or purchase digital media files stored on the cloud storage system 130. The consumer may either use media file processing module 114, use a third-party service, or visit a webpage via web client 140 or web client 113, to access the media file distribution system 120. The consumer may search for digital media files stored on the cloud storage system 130 by a variety of methods. For example, in various embodiments, the consumer may enter search terms, such as the name of a race, a date, a participant number, a participant name, a location, etc. In various embodiments, the consumer may select a race from among a list of presented races. In various embodiments, the mobile device 110 may use geographic location technology, date and/or time to suggest a relevant race to the consumer. The webpage or mobile application may display digital media file previews matching the consumer's search terms. Additionally, in various embodiments, the webpage or mobile application may display a live feed of digital media file previews being sent to the media file distribution system 120.

The consumer may select a digital media file preview and purchase the original digital media file associated with the preview via web client 113, media file processing module 114, or web client 140 (step 280). The consumer may transmit payment information to media file distribution system 120 by any method known in the art. The media file distribution system 120 may transmit a download link and/or a key-signed request to the consumer (step 290). In various embodiments, the signature may allow the consumer to present the required credentials to the cloud storage system 130 and therefore access and/or download a digital media file from the cloud storage system 130 (step 295). Thus, in various embodiments, the consumer may receive a digital media file taken by the mobile device 110 without the full quality digital media file being passed through the media file distribution system 120. This may conserve the bandwidth and necessary storage utilized by the media file distribution system 120.

In various embodiments, the consumer may purchase a version of the media file as opposed to the full resolution original digital media file. For example, the version may be a smaller file size than the digital media file, of lower resolution and/or quality than the original digital media file, a cropped portion of the original digital media file, JPG, JPEG, or a still image, GIF, AVI, mp4, short segment or watermarked version of the original media file if the original file is a video. In various embodiments, the media file distribution system 120 may remove the watermark, and the consumer may be able to share the digital media file preview with other consumers. In various embodiments, once any consumer has purchased the preview file, any consumer may be able to view the digital media file preview without the watermark on the webpage or mobile application.

In various embodiments, users may tag or edit a tag of a digital media file preview to add metadata to the file. For example, a user may view a digital media file preview and input or edit a bib number of an event participant shown in the preview file. Additionally, users may enter or edit a name of a person they recognize in the preview file. The user may enter or edit any metadata, such as event location, name of race, description of file (e.g. “single person”, “group”, or “finish line”) or any other metadata that may describe the preview file. In various embodiments, any user may associate metadata with the preview file. For example, the operator of the mobile device 110, an employee of the media file distribution system 120, a consumer browsing digital media file previews on a webpage or mobile application, or any other entity may tag the digital media file preview with metadata or edit the tag. The metadata may be stored by the media file distribution system 120 and associated with the preview file. In various embodiments, the media file distribution system 120 may obtain an event participant list for an event, and the media file distribution system 120 may associate a bib number with a participant name. Thus, in response to a bib number being tagged in a preview file, the media file distribution system 120 may tag the digital media file preview with the participant name associated with the bib number. Consumers may thus be enabled to search digital media file previews based on the tags input by any entity.

In various embodiments, the media file distribution system 120 may only allow certain users to add or edit the metadata associated with a preview file. In various embodiments, a photographer may add or edit any metadata associated with a preview file. In various embodiments, a consumer must be logged into system 100 in order to add or edit metadata associated with a preview file. However, in various embodiments, a consumer may only be allowed to add or edit metadata that the consumer associated with a preview file.

In various embodiments, a user may add an event to the media file distribution system 120. For example, a photographer may take a digital media file of a race, and determine that the race is not stored in the media file distribution system 120. The photographer may fill out an event registration form that contains sufficient information for the media file distribution system 120 to store the race information. Similarly, consumers may add an event to the media file distribution system 120 prior to generating any media files. In various embodiments, the mobile device 110 may establish a race based on geographic location technology, the presence of multiple users of system 100, date, time, the creation of a plurality of digital media files by photographers or any combination thereof. In other embodiments, anyone can create a race or other sporting event that can be photographed by others. In various embodiments, in response to an event being added to the media file distribution system 120, the media file distribution system 120 may access a website for the event and obtain a participant list for the event. In various embodiments, the media file distribution system may transmit a request to the event organizer and request a participant list. In various embodiments, once a race is created, any photographer can contribute media files to that race.

In various embodiments, portions of a purchase price for a digital media file may be distributed to participants in system 100. For example, in various embodiments, a photographer of a digital media file may receive a percentage or a flat fee in response to the digital media file being purchased by a consumer. In various embodiments, the photographer may receive a percentage or flat fee based on the type of media file purchased. In various embodiments, the photographer may set a purchase price for the digital media file. Additionally, in various embodiments, a user who tags a digital media file preview may receive a portion of the purchase price in response to the digital media file being purchased. Thus, photographers and users may be incentivized to upload digital media files and tag the digital media file previews in order for media file distribution system 120 to obtain more digital media files and metadata. In various embodiments, users may select to donate all or a portion of their earnings to a charity. The media file distribution system 120 may display a list of charities to the user, and the user may select one or more charities to automatically receive a portion of the user's earnings. In various embodiments, the media file distribution system 120 may indicate to the user that a larger portion of the purchase price may be donated to a charity as opposed to distributed to the user. This may encourage charitable donations and may have tax benefits for the media file distribution system 120.

In various embodiments, a digital media file preview may be marked with a symbol, such as an orange ribbon, indicating that a portion of the purchase price may be donated to charity. In various embodiments, an icon or symbol of the specific charity may be marked on the preview file. For example, a pink ribbon on a digital media file preview may indicate that proceeds from the digital media file preview will be donated to a particular charity dedicated to fighting breast cancer. Thus, consumers may be encouraged to purchase certain digital media files in order to contribute to charity.

In various embodiments, media file distribution system 120 may display a feed of digital media file previews on the mobile device 110 or web client 140. A consumer may filter the feed such that not all digital media file previews are displayed to the consumer. For example, the consumer may “follow” certain event participants or events. The consumer may indicate that the consumer only wishes for digital media file previews containing a certain bib number or participant name to be displayed in the feed. In various embodiments, a consumer may select to be notified each time a new digital media file preview containing certain metadata, such as a bib number or participant name, is uploaded to the media file distribution system 120. The media file distribution system 120 may notify the consumer by any available method, such as a notification on the webpage, mobile application, email, text message, phone call, etc.

In various embodiments, the media file distribution system 120 may suggest digital media file previews to a consumer based on information contained about the consumer. For example, the media file distribution system 120 may determine that the consumer has purchased a digital media file containing a particular event participant, and the media file distribution system 120 may display previews of other digital media files containing the same event participant within that same event or in other events. In various embodiments the media file distribution system 120 may notify a user when participants have signed up for or claimed metadata associating them as participants in a race, such as by claiming a bib number in a race. In various embodiments, the media file distribution system 120 may display new digital media file previews containing similar metadata to digital media file previews previously tagged by the consumer, and the media file distribution system 120 may suggest that the consumer tag or purchase the new digital media file previews.

In various embodiments, a consumer may store digital media files purchased by the consumer on web client 113, media file processing module 114, web client 140, system 100 or in a cloud-based account associated with the consumer. The consumer may be able to group digital media files based on the tags associated with the digital media files. In various embodiments, consumers may have thousands of digital media files stored in their accounts, and the user may select digital media files containing a particular participant number to view, or may sort the digital media files based on any other tag or metadata.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers.

A network may include any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®, cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website, a uniform resource locator (“URL”), a document (e.g., a Microsoft Word document, a Microsoft Excel document, an Adobe .pdf document, etc.), an “ebook,” an “emagazine,” an application or microapplication (as described below), an SMS or other type of text message, an email, facebook, twitter, MMS and/or other type of communication technology. In various embodiments, a channel may be hosted or provided by a data partner. In various embodiments, the distribution channel and/or the may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include Facebook®, foursquare®, Twitter®, MySpace®, Google+® LinkedIn®, and the like. Moreover, examples of mobile device communications include texting, email, and mobile applications for smartphones.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS). In various embodiments, the server may include web servers (e.g. APACHE, IIS, GWS, SUN JAVA SYSTEM WEB SERVER).

As those skilled in the art will appreciate, a device may include but is not limited to an operating system (e.g., Windows NT, 95/98/2000/CE/Mobile, OS2, UNIX, Linux, Solaris, MacOS, PalmOS, etc.) as well as various conventional support software and drivers typically associated with computers. A device may include but is not limited to any suitable personal computer, network computer, workstation, personal digital assistant, cellular phone, smart phone, minicomputer, mainframe or the like. A device can be in a home or business environment with access to a network. In various embodiments, access is through a network or the Internet through a commercially available web-browser software package. A device may implement security protocols such as Secure Sockets Layer (SSL) and Transport Layer Security (TLS). A device may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

As used herein, “transmit” may include sending electronic data from one system component to another. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems.

The computing unit of the device may be further equipped with an Internet browser connected to the Internet or an intranet using standard dial-up, cable, DSL or any other Internet protocol known in the art. Transactions originating at a device may pass through a firewall in order to prevent unauthorized access from users of other networks. Further, additional firewalls may be deployed between the varying components of the system to further enhance security.

A firewall may include any hardware and/or software suitably configured to protect ACS components and/or enterprise computing resources from users of other networks. Further, a firewall may be configured to limit or restrict access to various systems and components behind the firewall for devices connecting through a web server. Firewall may reside in varying configurations including Stateful Inspection, Proxy based, access control lists, and Packet Filtering among others. Firewall may be integrated within a web server or any other ACS components or may further reside as a separate entity. A firewall may implement network address translation (“NAT”) and/or network address port translation (“NAPT”). A firewall may accommodate various tunneling protocols to facilitate secure communications, such as those used in virtual private networking A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In various embodiments, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In various embodiments, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. Reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method comprising:
receiving, by a computer-based system for digital media distribution, a digital media file preview from a mobile device;
applying, by the computer-based system, a watermark to the digital media file preview;
signing, by the computer-based system and with a first key, the digital media file preview;
transmitting, by the computer-based system, the digital media file preview to a cloud storage system, wherein the cloud storage system accepts the digital media file preview signed by the computer-based system, and wherein the cloud storage system stores the digital media file preview;
receiving, by the computer-based system and from the mobile device, a request to upload an original media file associated with the digital media file preview to the cloud storage system;
signing, by the computer-based system and with a second key, the request to upload the original media file;
transmitting, by the computer-based system, the request to the mobile device, wherein the mobile device transmits the request and the original media file to the cloud storage system;
receiving, by the computer-based system, a purchase request from a consumer for the original media file;
signing, by the computer-based system and with a third key, the purchase request; and
transmitting, by the computer-based system, the purchase request to the cloud storage system.

2. The method of claim 1, further comprising:
associating, by the computer-based system, a latitude and a longitude with the digital media file preview.

3. The method of claim 1, further comprising:
receiving, by the computer-based system and from the cloud storage system, a unique identifier to access the original media file.

4. The method of claim 3, further comprising:
transmitting, by the computer-based system and to the consumer, the unique identifier to download the original media file.

5. The method of claim 4, wherein the consumer selects the unique identifier to access the original media file.

6. The method of claim 5, wherein the cloud storage system transmits the original media file to the consumer.

7. The method of claim 1, further comprising tagging, by the computer-based system, the digital media file preview with metadata.

8. An article of manufacture including a non-transitory, tangible computer-readable storage medium having instructions stored thereon that, in response to execution by a computer-based system for digital media distribution, cause the computer-based system to perform operations comprising:
receiving, by the computer-based system, a digital media file preview from a mobile device;
applying, by the computer-based system, a watermark to the digital media file preview;
signing, by the computer-based system and with a first key, the digital media file preview;
transmitting, by the computer-based system, the digital media file preview to a cloud storage system;
receiving, by the computer-based system and from the mobile device, a request to upload an original media file associated with the digital media file preview to the cloud storage system; and
signing, by the computer-based system and with a second key, the request to upload the original media file.

9. The article of manufacture of claim 8, wherein the operations further comprise:
receiving, by the computer-based system, a purchase request from a consumer for the original media file;
signing, by the computer-based system and with a third key, the purchase request; and
transmitting, by the computer-based system, the purchase request to the cloud storage system.

10. The article of manufacture of claim 8, wherein the operations further comprise:
receiving, by the computer-based system, a purchase request from a consumer for a modified version of the original media file;
signing, by the computer-based system and with a third key, the purchase request; and
transmitting, by the computer-based system, the purchase request to the cloud storage system.

11. The article of manufacture of claim 8, wherein the operations further comprise tagging, by the computer-based system, the digital media file preview with metadata.

12. The article of manufacture of claim 11, wherein the operations further comprise sorting, by the computer-based system, a plurality of digital media file previews including the digital media file preview based on the metadata.

13. The article of manufacture of claim 8, further comprising receiving, by the computer-based system, a search request based on metadata associated with the digital media file preview.

14. The article of manufacture of claim 8, wherein the digital media file preview comprises a participant in an event.

15. The article of manufacture of claim 8, further comprising receiving, by the computer-based system, metadata comprising a bib number of a person in the digital media file preview.

16. A system comprising:
a processor for digital media distribution,
a tangible, non-transitory memory configured to communicate with the processor,
the tangible, non-transitory memory having instructions stored thereon that, in response to execution by the processor, cause the processor to perform operations comprising:
receiving, by the processor, a digital media file preview from a mobile device;
applying, by the processor, a watermark to the digital media file preview;
signing, by the processor and with a first key, the digital media file preview;
transmitting, by the processor, the digital media file preview to a cloud storage system;
receiving, by the processor and from the mobile device, a request to upload an original media file associated with the digital media file preview to the cloud storage system; and
signing, by the processor and with a second key, the request to upload the original media file.

17. The system of claim 16, wherein the processor receives a purchase request from a consumer for a version of the original media file associated with the digital media file preview, wherein the version of the original media file comprises at least one of a smaller file size of the original media file, a lower resolution digital media file, a cropped portion of the original media file, a still image of a video file, a GIF, a segment of a video file, or a watermarked version of a video file.

18. The system of claim 17, wherein the cloud storage system delivers the version of the original media file to the mobile device.

19. The system of claim 16, wherein the mobile device uses a signed request from the processor to upload the digital media file preview to the cloud storage system.

20. The system of claim 16, wherein a consumer tags the digital media file preview with metadata.
